(19) United States
(12) Patent Application Publication
(10) Pub. No.: US 2005/0187788 A1
(43) Pub. Date: Aug. 25, 2005

(54) Method for monitoring the disribution channel of a precription drug

(76) Inventor: Eddwin Rivera, Miami, FL (US)

Correspondence Address: Ruben Alcoba, Esq., 17347 SW 20th CT, Miramar, FL, 33029, US

(21) Appl. No.: 10/785,269

(22) Filed: Feb. 24, 2004

(51) Int. Cl. G06F 17/60; G08B 13/08

(52) U.S. Cl. 705/2; 340/549

(57) ABSTRACT

The present invention is directed to a method for monitoring the distribution channel of a pharmaceutical drug, wherein the method allows governmental agencies to spot any wrongdoings by any parties in the distribution chain.

### BACKGROUND

There is a need to provide a method for tracking a pharmaceutical drug through its distribution chain that is readily accessible to all parties having an interest in the drug.

The current method of tracking a pharmaceutical drug through its distribution channel depends on each party involved in the chain creating a paper trail that is physically verifiable by an administrative state/government agency.

The current process of monitoring the distribution of a prescription drug is a three step process. First, the distributor/manufacturer of the drug creates a handwritten pedigree for each drug sent to a third party. Second, the distributor/manufacturer of the drug mails or faxes a copy of the pedigree to the third party. Lastly, the distributor/manufacturer physically stores the pedigree for agency review.

The current invention provides a method that will post a pedigree for each drug distributed on a website of the distributor/manufacturer/agency. The pedigree will be accessible to the third party purchaser of the drug and the monitoring agency at the time of distribution.

An object of this invention is to reduce the paperwork involved in the distribution of pharmaceutical drugs.

Another object of this invention is to allow state/government agencies to monitor the distribution of pharmaceuticals from a centralized location.

A further object of the invention is to prevent counterfeiting of prescription drugs.

Yet another object of the invention is that all interested parties involved in the distribution of the drug are able to see the pedigree/(distribution channels) of the drug at the time of distribution.

For the forgoing reasons, there is a need for a method of monitoring the distribution channels of a pharmaceutical drug on a website that is accessible to third party purchasers of the drug and to governmental monitoring agencies.

### SUMMARY

The present invention is directed to a method for monitoring the distribution channel of a pharmaceutical drug, wherein the method allows governmental agencies to spot any wrongdoings by any parties in the distribution chain. The method has the added bonuses of reducing the paperwork involved in the monitoring of the drugs and reduces the man-hours required to monitor each drug transaction. The method for monitoring the distribution channel of a pharmaceutical drug comprises the steps of first placing a tag on the pharmaceutical drug to be shipped to a third party. Then recording the pharmaceutical drug's transaction on a database along with the tag's identification value that corresponds to the drug. You then create an electronic pedigree on the database that will correspond to the radio frequency tag's identification value. The shipper then loads the pedigree to a website, wherein the website will store the pedigree for third party viewing. Then the shipper would provide the third party with an alias and an access code to the website so that the third party can monitor the pedigree of the drug that is to be received. Lastly, shipping the pharmaceutical drug to the third party.

The website where the pedigree information is uploaded can be owned and maintained by the shipper, an independent source, or a governmental agency in charge of monitoring pharmaceuticals.

These and other features, aspects, and advantages of the present invention will become better understood with reference to the following description and appended claims.

### DEFENITIONS

Pedigree means a document in form approved by a monitoring agency and containing information that records each distribution of any given legend drug, from sale by a pharmaceutical manufacturer, through acquisition and sale by any wholesaler or repackager, until final sale to a pharmacy or other person administering or dispensing the drug. The information required to be included on a legend's drug pedigree paper must at least detail the amount of the legend drug, its dosage form and strength, its lot numbers, the name and address of each owner of the legend drug and his identification/signature, its shipping information, including the name and address of each person certifying delivery or receipt of the legend drug, and a certification that the recipient has authenticated the pedigree papers. This definition is not to be limiting, but is meant to be used as a guideline as to what normal monitoring agencies require.

### DESCRIPTION

A method for monitoring the distribution channel of a pharmaceutical drug, comprising the steps of placing a radio frequency tag on a quantity of a pharmaceutical drug that is to be shipped to a third party; saving the pharmaceutical drug's quantity on a database along with the radio frequency tag's identification value that corresponds to the drug; creating an electronic pedigree on the database that will correspond to the radio frequency tag's identification value; loading the pedigree to a website, wherein the website will store the pedigree for third party viewing; providing the third party with an alias and an access code to the website so that the third party can monitor the pedigree of the drug that is to be received; and shipping the pharmaceutical drug to the third party.

In the placing the radio frequency tag on the pharmaceutical drug, the shipper places the tag so that any attempts to tamper with the drug shipment causes damage to the tag, thereby placing the recipient of the drug on notice that the shipment has been tampered with.

In the saving the pharmaceutical drug's quantity on a database along with the radio frequencies tag's identification value, the shipper creates a log for each shipment prepared which is further identified by the identification value given to the tag.

In the creating the electronic pedigree on the shipper's database, the shipper fills out all of the required information, as required by the monitoring agency, and adds the tag's previously recorded information. This database is the property of the shipper and can be reviewed by the monitoring agency.

In the loading the pedigree, the shipper uploads all of the pedigree information regarding the drug to a website. The website can be owned and operated by the shipper, an independent agency, or a governmental agency. The website is an engine used to enter a separate database that holds all of the shippers transactions. The website can be accessed by any third party, once the shipper gives an alias and an access code to the third party.

When the shipper is the proprietor of the website, the invention further comprises of the step of giving an alias and an access code to a monitoring agency of the pharmaceutical drug shipped, wherein the access code will allow the agency to see the pedigree of the drug.

In another embodiment of the invention, the alias and access code given to the monitoring agency shall be the same for all the pharmaceutical drugs shipped by the shipper, this allows the monitoring agency to view all of the drugs shipped by the shipper at any given time.

When the independent party is the proprietor/operator of the website, the shipper uploads the pedigree information to the independent party's website, the independent party then saves the pedigree information to the independent party's database, the pedigree information can then be accessed by any third party, once the third party is given a proper alias and password. The independent party further gives the monitoring agency an alias and access code to review the independent party's database of pharmaceutical transactions. The independent party might assign a single alias and access number to the governmental agency for each transaction or may give a universal access number to the agency.

This invention is used as a near real time tracking method of monitoring pharmaceutical drug transactions over the Internet. It allows a monitoring agency or any third party receiving a drug shipment to monitor the distribution chain of the drug. Ideally, when the shipper uploads the drug's pedigree information, the monitoring agency will see the transaction in real time.

An advantage of this invention is that it reduces the paperwork involved in the distribution of pharmaceutical drugs.

Another advantage of this invention is that it allows state/government agencies to monitor the distribution of pharmaceuticals from a centralized location.

A further advantage of this invention is that it prevents counterfeiting of prescription drugs.

Yet another advantage of this invention is that all interested parties involved in the distribution of the drug are able to see the pedigree/(distribution channels) of the drug at the time of distribution.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar nature.

1. A method for monitoring the distribution channel of a pharmaceutical drug, comprising the steps of:
placing a radio frequency tag on a quantity of a pharmaceutical drug that is to be shipped to a third party;
saving the pharmaceutical drug's quantity on a database along with the radio frequency tag's identification value that corresponds to the drug;
creating an electronic pedigree on the database that will correspond to the radio frequency tag's identification value;
loading the pedigree to a website, wherein the website will store the pedigree for third party viewing;
providing the third party with an alias and an access code to the website so that the third party can monitor the pedigree of the drug that is to be received; and
shipping the pharmaceutical drug to the third party.

2. The method of claim 1, wherein the shipper is the proprietor of the website.

3. The method of claim 2, comprising the step of giving an alias and an access code to a monitoring agency of the pharmaceutical drug shipped, wherein the access code will allow the agency to see the pedigree of the drug.

4. The method of claim 3, wherein the alias and access code given to the monitoring agency shall be the same for all the pharmaceutical drugs shipped by the shipper, this allows the monitoring agency to view all of the drugs shipped by the shipper at any given time.

5. The method of claim 1, wherein an independent party is the proprietor of the website.

6. The method of claim 5, comprising the step of the independent party giving an alias and an access code to a monitoring agency of the pharmaceutical drug, wherein the access code will allow the agency to see the pedigree of the drug.

7. The method of claim 6, wherein the alias and access code given to the monitoring agency shall be the same for all the pharmaceutical drugs shipped by the shipper, this allows the monitoring agency to view all of the drugs shipped by the shipper at any given time.

8. The method of claim 1, wherein a monitoring agency of the pharmaceutical drug is the proprietor of the website.
